(19) United States
(12) Patent Application Publication
(10) Pub. No.: US 2003/0236890 A1
(43) Pub. Date: Dec. 25, 2003

(54) Wireless communication device and method for sharing device resources

(75) Inventors: Roger A. Hurwitz, Portland, OR (US); Marion H. Shimoda, Aloha, OR (US); Rajesh P. Banginwar, Hillsboro, OR (US); Thomas M. Cronin, Hillsboro, OR (US); Travis T. Shultz, Hillsboro, OR (US); Douglas C. Sommer, Portland, OR (US)

Correspondence Address: SCHWEGMAN, LUNDBERG, WOESSNER & KLUTH, P.A., P.O. BOX 2938, MINNEAPOLIS, MN, 55402, US

(73) Assignee: Intel Corporation

(21) Appl. No.: 10/183,123

(22) Filed: Jun. 25, 2002

(51) Int. Cl. G06F 15/16

(52) U.S. Cl. 709/227

(57) ABSTRACT

A wireless device resource sharer (WDRS) proxies incompatible communications between wireless devices. A wireless network may be formed allowing both compatible and incompatible wireless devices to communicate therebetween. The WDRS allows incompatible wireless devices to appear as compatible devices. In this way, the WDRS may be “invisible” to such devices allowing the wireless devices to be part of a network of “compatible” devices. The WDRS includes physical interfaces to communicate with compatible and incompatible wireless devices in accordance with various wireless network physical layers. The WDRS also includes a proxy server to proxy incompatible network application layer protocols between wireless devices. The WDRS may also share storage and processing resources with wireless devices. A policy manager within a wireless device regulates resource sharing with other devices. A wireless device may also share resources directly with other wireless devices, and may automatically and intelligently select network connectivity.

### FIELD OF THE INVENTION

The present invention pertains to electronic communications, and in particular, to wireless devices and communications between wireless devices.

### BACKGROUND OF THE INVENTION

Many people, including business professionals, carry one or more wireless communication devices. Each device may serve a different purpose. For example, a person may carry a wireless telephone for making telephone calls, a personal digital assistant (PDA) for storing documents, viewing email, and keeping a calendar, a portable or laptop computer for word processing, a MP3 player for listing to audio, or a web-tablet for web communications. People carrying these wireless and portable devices also come in-proximity to each other, such as during a meeting, in the office area, at a convention, or within a restaurant or cafeteria. These people may wish to share information on their devices with others but compatibility issues between the various devices make this a difficult prospect. Furthermore, a person may wish to utilize processing resources available on another device because while many of these portable wireless devices lack significant processing capability, other devices may have available or unused processing ability.

One reason that many wireless devices are incompatible with each other is because different wireless devices may be configured for communications in accordance with a particular wireless network physical layer. For example, a wireless device may only have a Bluetooth transceiver for communications in accordance with the Bluetooth standard. Another wireless device may only have an IEEE 802.11 transceiver for communications in accordance with one of the IEEE 802.11 standards. Another wireless device may only have an infrared transceiver for communications over an infrared serial data link in accordance with the IrDA standard.

Another reason that many wireless devices are incompatible with each other is because different wireless devices, even when configured for communications in accordance with compatible wireless network physical layers, may not be able to communicate with each other or share resources because they operate in accordance with different network application layer protocols. For example, even though two wireless devices may communicate using the IEEE 802.11b standard, the devices may utilize different network application layer protocols such as JINI or universal plug and play (UPnP).

### BRIEF DESCRIPTION OF THE DRAWINGS

The appended claims point out different embodiments of the invention with particularity. However, the detailed description presents a more complete understanding of the present invention when considered in connection with the figures, wherein like reference numbers refer to similar items throughout the figures and:

FIG. 1 is a diagram illustrating wireless device resource sharing in accordance with an embodiment of the present invention;

FIG. 2 is a functional block diagram of a wireless device resource sharer in accordance with an embodiment of the present invention;

FIG. 3 is a functional block diagram illustrating direct resource sharing between wireless devices in accordance with an embodiment of the present invention;

FIG. 4 is a flow chart of a resource sharing procedure in accordance with an embodiment of the present invention; and

FIG. 5 is a flow chart of a network forming procedure in accordance with an embodiment of the present invention.

### DETAILED DESCRIPTION

The following description and the drawings illustrate specific embodiments of the invention sufficiently to enable those skilled in the art to practice it. Other embodiments may incorporate structural, logical, electrical, process, and other changes. Examples merely typify possible variations. Individual components and functions are optional unless explicitly required, and the sequence of operations may vary. Portions and features of some embodiments may be included in or substituted for those of others. The scope of the invention encompasses the full ambit of the claims and all available equivalents.

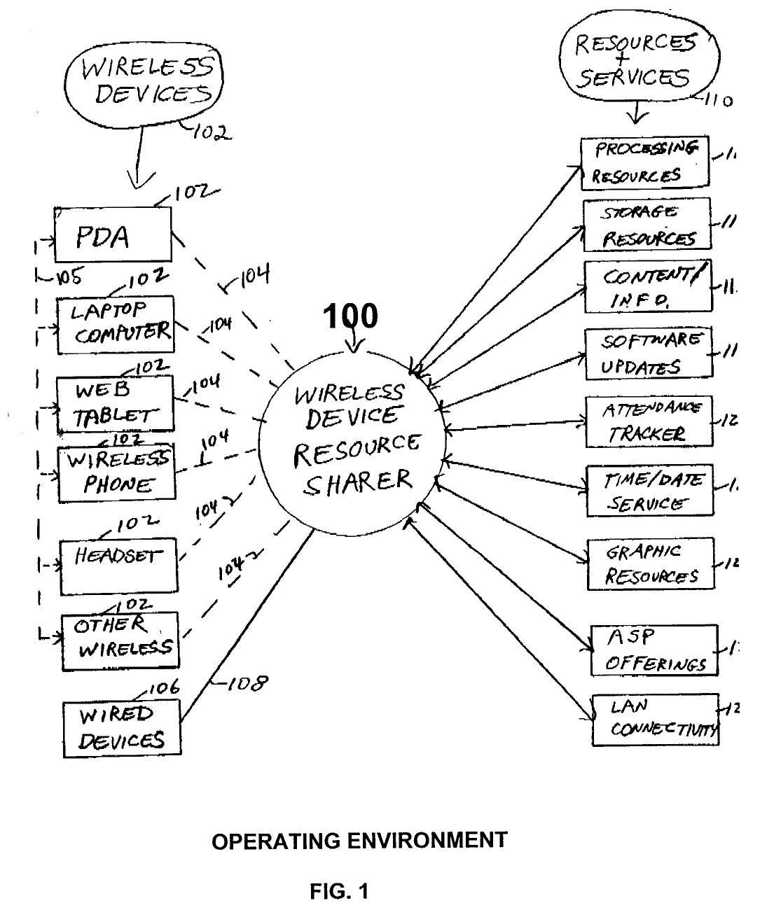

FIG. 1 is a diagram illustrating wireless device resource sharing in accordance with an embodiment of the present invention. In one embodiment, the present invention relates to resource sharing between wireless devices using a wireless device resource sharer. In another embodiment, the present invention relates to direct resource sharing between wireless devices. In yet another embodiment, the present invention relates to intelligent wireless network physical layer selection by wireless devices. Wireless devices that implement different wireless network physical layers may communicate and share resources. Wireless devices that implement different network application layer protocols may also communicate and share resources.

A wireless device resource sharer (WDRS), such as WDRS 100, may proxy incompatible communications between wireless devices. A wireless network may be formed allowing both compatible and incompatible wireless devices to communicate therebetween. In one embodiment, the WDRS allows incompatible wireless devices to appear as compatible devices. In this way, the WDRS may be “invisible” to such devices allowing the wireless devices to be part of a network of “compatible” devices. The WDRS may include physical interfaces to communicate with compatible and incompatible wireless devices in accordance with various wireless network physical layers. The WDRS may also include a proxy server to proxy incompatible network application layer protocols between wireless devices. The WDRS may also share storage and processing resources with wireless devices. A policy manager within a wireless device regulates resource sharing with other devices. In one embodiment, a connectivity decision-making (CDM) element may evaluate connectivity-related inputs for use in making connectivity decisions. The connectivity-related inputs may include power consumption of a particular wireless network physical layer when reduced power consumption is identified as desirable. The connectivity-related inputs may include connection speed of the particular wireless network physical layer when high connection speed is identified as desirable. In alternate embodiments, a wireless device may also share resources directly with other wireless devices, and may automatically and intelligently select network connectivity utilizing, for example, the CDM element.

WDRS 100 enables a plurality of in-proximity wireless communication devices (WCDs) 102 to communicate and share resources including services among each other and with WDRS 100. In one embodiment, WDRS 100 also enables in-proximity WCDs 102 to utilize resources and services of external networks. WCDs 102 may include, for example, personal digital assistants (PDAs), laptop and portable computers with wireless communication capability, web tablets, wireless telephones, wireless headsets, pagers, instant messaging devices, MP3 players, digital cameras, and other devices that may receive and/or transmit information wirelessly. WDRS 100 may be located, for example, in a conference or meeting room or other location where one or more wireless devices may be, present. WDRS 100 may also be located at conferences where a large number of people may congregate and attend meetings. WCDs 102 often are incompatible with each other making direct as well as indirect communicate difficult, if not impossible. Further, WCDs 102 may often lack processing capability that may be desired, for example, during a meeting. WDRS 100 may allow such business professionals to share information and utilize the processing resources and services of WDRS 100 and/or other WCDs 102.

In one embodiment, WDRS 100 and in-proximity WCDs 102 may operate similar to an ad-hoc network. WDRS 100 may identify WCDs 102 that are in-proximity to or nearby WDRS 100 and establish communication links 104 in accordance with a particular wireless network physical layer suitable for a particular WCD 102. WDRS 100 may also implement a service discovery protocol (SDP) to identify in-proximity WCD resources and share such information with in-proximity WCDs 102. In response to resource requests from in-proximity WCDs 102, WDRS 100, among other things, may authenticate the in-proximity WCDs 102 requesting the resource, may proxy incompatible network application layer protocols between in-proximity WCDs 102, perform the resource-sharing request itself or invoke the resources of another of in-proximity WCDs 102 to perform the resource-sharing request. In addition to resource sharing, WDRS 100 may also provide services to in-proximity WCDs 102. In one embodiment, WCDs 102 may share resources directly over links 105.

One example of the resources that WDRS 100 may share among in-proximity WCDs 102 includes processing resources 112. Because WCDs 102 may have limited processing capability, in-proximity WCDs 102 may wish to off-load processing to a processing resource of WDRS 100. For example, one of in-proximity WCDs 102 may send speech packets to WDRS 100 for performing speech recognition and converting the speech packets to text. The speech packets may come from real-time audio from a conversation taking place during a meeting. Accordingly, persons attending the meeting may receive a real-time “transcription” of what was spoken at the meeting from WDRS 100.

In another example, one of in-proximity WCDs 102, such as a PDA, may send data representing hand written notes during a meeting. The PDA may not have handwriting recognition software able to handle such processing. WDRS 100 may perform handwriting recognition and transmit the notes to one or more of in-proximity WCDs 102 of persons attending the meeting. Accordingly, the persons attending a meeting may receive real-time notes of one or more of the other persons attending the meeting. Other examples of processing that may be performed on behalf of one of WCDs 102 include video compression and decompression, natural language processing and multimedia playback.

Another example of resources that WDRS 100 may share includes storage resources 114. WDRS 100 may include storage elements such as a hard-drive, a CD-ROM and a memory for storing data in response to requests by one of in-proximity WCDs 102. The data, for example, may be tagged for retrieval by a particular one or more of wireless devices 102. Documents, for example, may be archived in WDRS 100. In one embodiment, WDRS 100 may provide for a persistent storage allowing it to serve, for example, as an archival storage unit for meeting participants in a conference room. In this embodiment, meeting information may be tagged with identifiers to allow access by certain persons, such as meeting attendees.

In another embodiment, WDRS 100 may share content storage 116. In this example, content such as company news and other information may be available to in-proximity WCDs 102. WDRS 100 may also provide software updates 118 to in-proximity WCDs 102. For example, a corporation may wish to automatically upgrade employees' PDA or laptop computer software when the employee is in a conference room where WDRS 100 is located. In another embodiment, WDRS 100 may receive content and/or software updates from one of WCDs 102.

In another embodiment, WDRS 100 may include attendance tracker 120 for providing attendance-tracking services. For example, during a meeting WDRS 100 may automatically identify parties attending a meeting through a person's in-proximity WCD 102. WDRS 100 may be configured to automatically store meeting attendance information along with other meeting information, and may provide the meeting attendance information to the meeting attendees and others, for example, through in-proximity WCDs 102.

WDRS 100 may also offer time and date synchronization services 122 to in-proximity WCDs 102. Time and date synchronization services 122 may update the time and/or date of an in-proximity WCD 102. For example, a person attending a meeting arriving from another time zone may wish to have their in-proximity WCD updated to the local time and date. Persons attending a meeting, for example, may also wish to have the time on their in-proximity WCD synchronized with the time of other meeting attendees.

In another embodiment, WDRS 100 may also utilize and share graphics resources 124 among in-proximity WCDs 102. For example, WDRS 100 may display information received from one or more of in-proximity WCDs 102 on a display such as overhead projector, computer display or monitor. In one embodiment, WDRS 100 may multiplex information received from more than one WCDs 102 for displaying. WDRS 100 may also share printing resources and may couple with a common printer to allow in-proximity WCDs 102 to print using the common printer.

In another embodiment, WDRS 100 may also provide application service provider (ASP) offerings 126 and may allow WCDs 102 to operate, for example, in a client-server mode. For example, an application may be hosted on WDRS 100. This may be particularly useful when in-proximity WCDs 102 do not have the processing capability or software to run the hosted application, when the application is not available on the in-proximity WCD 102, or when the application requires connectivity to an external server. In one embodiment, WDRS 100 may also provide local area network (LAN) connectivity 128 allowing wireless devices to communicate, for example, with a corporate LAN, an intranet or the Internet. LAN connectivity 128 may include an enterprise LAN connectivity to allow remote management of WDRS 100. In another embodiment, WDRS 100 may receive content and/or software updates through LAN connectivity 128. In yet another embodiment, a WCD 102 may have a policy manager, which sets policies for allowing resource sharing with WDRS 100 and other WCDs 102.

In still yet another embodiment of the present invention, WDRS 100 facilitates resource sharing with wired devices 106, which may be coupled to WDRS 100 over a wireline connection 108. In this embodiment, wired devices 106 may directly couple to WDRS 100 and share resources similar to the way in-proximity WCDs 102 share resources.

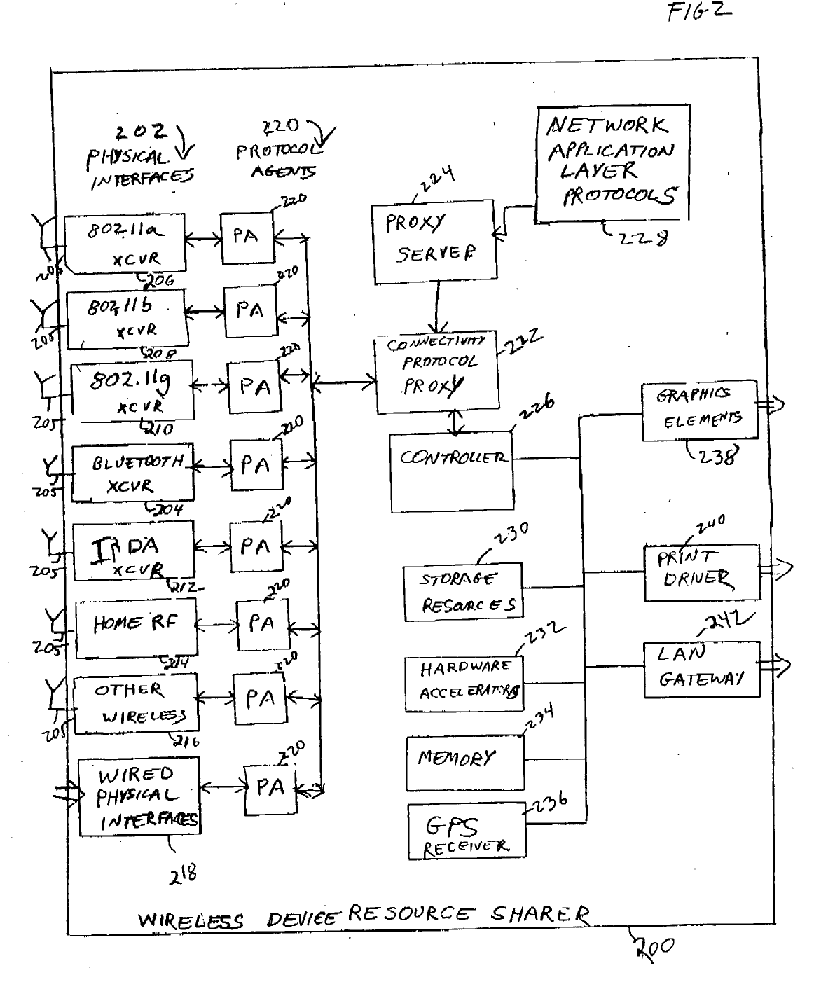

FIG. 2 is a functional block diagram of a wireless device resource sharer in accordance with an embodiment of the present invention. Wireless device resource sharer 200 may be suitable for use as WDRS 100 (FIG. 1), although other configurations for WDRS 100 are also suitable. WDRS 200 may have a plurality of physical interfaces 202 communicate with wireless communication devices, such as WCDs 102 (FIG. 1) in accordance with wireless network physical layers that implement different standards. Physical interfaces 202 may be comprised of transceivers for providing communications in accordance with various communication standards including physical connectivity protocols that include wireless local area network (WAN) protocols and/or wireless personal area network (WPAN) protocols. For example, WDRS 200 may include Bluetooth transceiver 204 to communicate with in-proximity WCDs 102 (FIG. 1) in accordance with the Bluetooth standard. WDRS 200 may also include transceivers 206, 208 and 210 to communicate with in-proximity WCDs 102 (FIG. 1) in accordance with, respectively, the IEEE 802.11a standard, the IEEE 802.11b standard, and the IEEE 802.11g standard. WDRS 200 may also include infrared transceiver 212 to support an infrared serial data link with in-proximity WCDs 102, which may be in accordance with the Infrared Data Association (IrDA) standard. WDRS 200 may also include home-RF transceiver 214 to communicate with in-proximity WCDs 102 in accordance with the Home-RF standard. The Home-RF standard, for example, may be in accordance with a Home-RF Working Group (HRFWG) standard. WDRS 200 may also include other wireless transceivers 216 to communicate in accordance with other wireless network standards or wireless network physical layers.

Many WCDs use different and often incompatible wireless communication standards. In one embodiment of the present invention, at least one physical interface 202 may be provided for the various wireless network communication standards used by a WCD 102 (FIG. 1). The various different physical interfaces 202 may allow almost any WCD to communicate with WDRS 200.

Although physical interfaces 202 are illustrated as separate functional elements, one or more of physical interfaces 202 may be combined. Additionally, although FIG. 2 illustrates only one of each type of physical interface 202, WDRS 200 may comprise more than one of any of the physical interfaces. In one embodiment, WDRS 200 may be configured to provide communication links with one or more of the physical interfaces in various directions. For example, when WDRS 200 may be designed to operate in the center of a conference room and may be configured to provide communication links with one or more of the physical interfaces over a 360-degree range. For example, WDRS 200 may mount on a wall, or in a comer, and may provide communication links with one or more of the physical interfaces over a 180-degree range in azimuth and 90-degree range in elevation. Each of physical interfaces 202 may be configured with one or more antenna 205 to support such requirements.

In one embodiment, WDRS 200 may include one or more wired physical interfaces 218 for providing wired communications with portable communication devices. For example, wired physical interfaces 218 may include a USB interface, a cable interface, and/or an Ethernet interface. A WCD may be able to communicate over wired physical interface 218 when the WCD supports wired connectivity.

WDRS 200 may also include one or more protocol agents (PA) 220. Protocol agents 220 may be associated with a particular one of physical interfaces 202. Protocol agents 220 interface information with physical interfaces 202 and may, for example, format data packets in accordance with the wireless network physical layer of the associated physical interface 202. Although protocol agents 220 are illustrated as separate functional elements, in one embodiment of the present invention, protocol agents 220 may be software agents running on a processor which may be part of controller 226. Protocol agents 220 communicate with connectivity protocol proxy 222 to allow the routing of data packets among the protocol agents 220.

WDRS 200 may also include proxy server 224 to proxy network application layer protocols 228 allowing data to be converted from one network application layer protocol to another. Network application layer protocols, may include, for example, file transfer protocols. For example, one WCD may transfer data in accordance with the Bluetooth network application layer protocol while another WCD 102 may wish receive data in accordance with a universal plug and play (UPnP) or a JINI network application layer protocol. Proxy server 224 may proxy the incompatibility of different network application layer protocols. The proxy between different network application layer protocols may be required even when WCDs 102 are communicating in accordance with the same wireless network physical layer.

WDRS 200 may include storage resources 230 which may be shared by in-proximity WCDs 102 (FIG. 1). Storage resources 230 may include, for example, a hard disk drive, a CD-ROM drive, and/or a memory. WDRS 200 may also include processing resources such as hardware accelerators 232 which also may be shared by in-proximity WCDs 102 (FIG. 1). Hardware accelerators 202 may be suitable for performing speech and handwriting recognition. Other processing resources may be used to perform image processing and audio processing which may be utilized by in-proximity WCDs such as digital cameras and MP3 players. The processing resources of WDRS 200 may also include general-purpose processors configurable with software for performing processing requests by in-proximity WCDs 102 (FIG. 1). Memory 234 may store, for example, programming instructions and data for the operation of WDRS 200.

In one embodiment, WDRS 200 may include GPS receiver 236 to determine a location of WDRS 200. The location information may be requested by or provided to in-proximity WCDs 102 (FIG. 1) and may be used by WCDs 102 to update calendar applications, for example.

WDRS 200 may also include graphics elements 238 to interface with graphical display components such as overhead projectors, liquid crystal displays, cathode ray tubes, etc. WDRS 200 may include such display components, or may be coupled to such display components. Graphic elements 238 may allow in-proximity WCDs 102 to share graphic resources, such as a display, during a meeting. WDRS 200 may multiplex information, such as slides, from several meeting participants for displaying on an overhead projector. WDRS may also include print driver 240, which may interface with a printer allowing WCDs 102 to share printing resources.

In one embodiment, WDRS 200 may include a gateway such as LAN gateway 242 to access a network such as an intranet or the Internet. LAN information and resources may be shared with the WCDs.

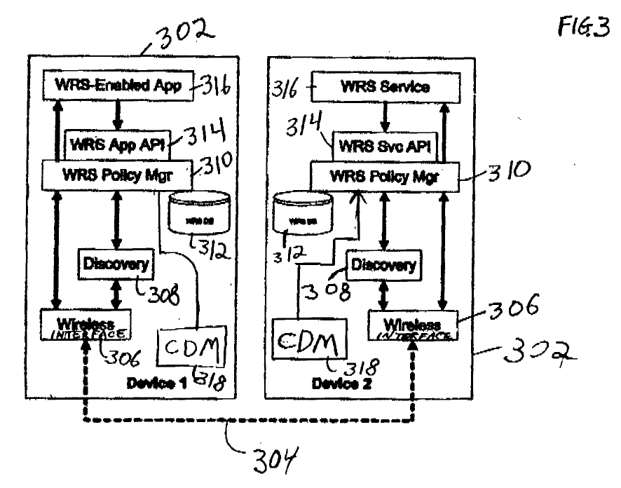

FIG. 3 is a functional block diagram illustrating direct resource sharing between wireless devices in accordance with one embodiment of the present invention. Two or more in-proximity WCDs 302 may discover each other and use the resources of each other in accordance with policies established by each of the in-proximity WCDs. In this embodiment, WCD 302 may communicate directly over link 304. Link 304 may correspond with link 105 (FIG. 1). In this embodiment, it may not be necessary for WCDs to utilize a common element therebetween such as WDRS 100 (FIG. 1). WCD 302 may also be suitable for use as one of WCDs 102 (FIG. 1), but this is not a requirement.

In this embodiment, WCD 302 includes wireless interface 306 which may provide wireless communications in accordance with one or more wireless physical connectivity protocols. For example, wireless interface 306 may communicate using the IEEE 802.11a standard, the IEEE 802.11b standard, the IEEE 802.11g standard, the infrared data association (IrDA) standard, the Bluetooth standard, a Home-RF standard, and/or other wireless network physical layers.

Discovery element 308 is a functional element that allows WCD 302 to discover in-proximity WCDs, and may also allow WCD 302 to discover sub-devices and services available through an in-proximity WCD. Discovery element 308 may implement one or more discovery protocols, including, for example, network application layer protocols such as Bluetooth, UPnP, or JINI. Accordingly, through the use of discovery element 308, in-proximity WCDs 302 may communicate and share resources using communication techniques, which are often incompatible.

In this embodiment, WCD 302 includes wireless resource sharing (WRS) policy manager 310. Policy manager 310 may apply WRS policies based on user input and information, which may be stored in policy management database 312. Policy manager 310 may keep a log of WRS activities and may store the log in database 312. Policy manager 310 may include a resolution of permissions for WRS of WCD 302, as well as preferences for communicating with other devices depending on attributes of WCD 302 and those specified by the device owner. For example, a WCD may not wish to share processing resources when battery power is low, but may wish to share resources when batter power is high or when the WCD is operating on AC power. Policy manger 310, for example, may permit WCD 302 to share information only with certain other WCDs such as WCDs of company employees or WCDs of project personnel.

Policy manager 310 may be implemented as a software module and may provide an interface with discovery element 308 and wireless interface 306. In one embodiment, policy manager 310 may perform other functions, such as caching and background operations to enhance the performance of resource sharing activities.

WCD 302 may also include WRS application programming interface (API) 314. API 314 provides an interface with various applications 316, and may, for example, determine a wireless network physical layer, a network application layer protocol and/or a discovery protocol from a particular application. API 314 may be invoked by a particular one of applications 316 to discover and invoke a resource on another WCD. Applications 316 may include several WRS-enabled applications, which may utilize the resources of another WCD.

Accordingly, resource sharing among WCDs, which communicate using different and possibly incompatible wireless network physical layers, is accomplished. Furthermore, resource sharing among WCDs, which implement incompatible network application layer protocols is easily accomplished even for network application layer protocols that may not generally be suitable for wireless communications, such as UPnP. Furthermore, this embodiment of the present invention allows each WCD 302 to implement a set of policies to regulate WRS. Although WCD 302 is illustrated as having separate functional elements 306 through 316, WCD 302 may comprise one or more processors configured with software to implement these functional elements.

In one embodiment of the present invention, WCD 302 may intelligently and automatically select a wireless network physical layer for network connectivity. For example, a laptop computer with wireless capability currently using an IEEE 802.11b wireless LAN standard for connectivity may enter a room with a Bluetooth access point. The laptop computer may automatically switch to Bluetooth connectivity, for example, to save power when running on battery. In accordance with this embodiment, WCD 302 may include connectivity decision-making element (CDM) 318 to evaluate inputs to base connectivity decisions on. WCD 302 may include a policy manager, such as policy manager 310, to manage user selected and user-designated policies for network connectivity. For example, a user may designate that Ethernet connectivity takes highest-priority, or that IEEE 802.11b connectivity is selected over Bluetooth connectivity when power usage is not important. The user may designate that IEEE 802.11b connectivity is selected over Bluetooth connectivity when connection speed is important depending on the application, or when the device is operating on battery power.

Connectivity decision-making element 318 may evaluate other inputs such as battery power level or remaining battery power for network connectivity selection. For example, connectivity decision-making element 318 may choose the more optimum method of network connectivity in terms of power consumption when battery power is low.

Connectivity decision-making element 318 may also make network connectivity decisions based on location. For example, when a wired-link is available, such as when the device is coupled to docking station or phone line, connectivity decision-making element 318 may select the wired-link depending on, for example, application requirements and parameters of the wired-link.

Connectivity decision-making element 318 may also evaluate network status to make connectivity decisions. For example, if a Bluetooth connection fails, connectivity decision-making element 318 may instruct the device to automatically switch to IEEE 802.11b connectivity.

In one embodiment, connectivity decision-making element 318 may evaluate past pattern usage. For example, connectivity decision-making element 318 may generate a database of prior connectivity mechanisms, which may be used in selecting a current connectivity mechanism. For example, if a Bluetooth connection at a particular location provided less than the usual bandwidth or experienced connectivity problems, (e.g., maybe as a result of going out of range) connectivity decision-making element 318 may, for example, switch to IEEE 802.11b connectivity, which may provide a better range. In accordance with this embodiment, a WCD may provide seamless transfer between different network connectivity mechanisms including, seamless connectivity between wired and wireless connectivity mechanisms.

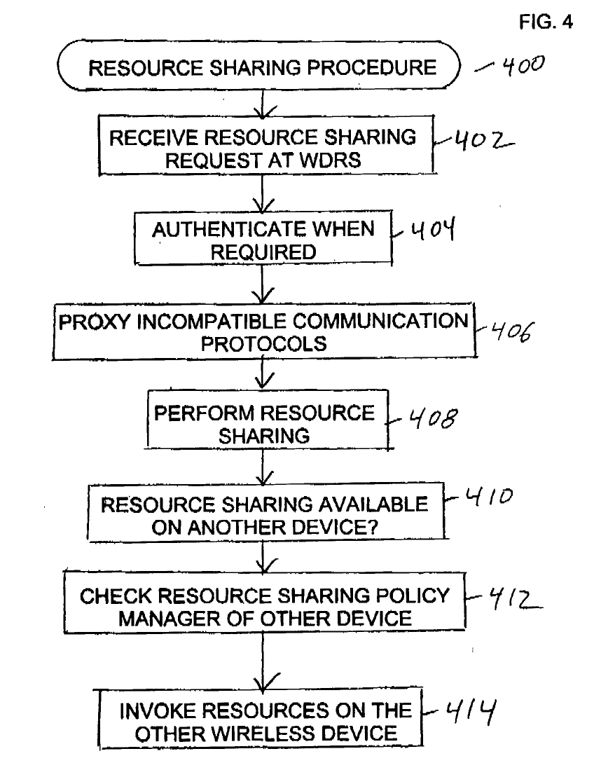

FIG. 4 is a flow chart of a resource sharing procedure in accordance with an embodiment of the present invention. Resource sharing procedure 400 may be performed by a wireless communication device such as WDRS 100 (FIG. 1), or WDRS 200 (FIG. 2) although other devices may also be suitable for performing procedure 400. In an alternate embodiment, wireless devices, such as WCDs 302 (FIG. 3), may perform all or portions of procedure 400 when, for example, direct resource sharing between devices is implemented. Resource sharing procedure 400 may permit wireless devices with incompatible physical interfaces to communicate and share resources therebetween. Furthermore, resource sharing procedure 400 may permit wireless devices using incompatible network application layer protocols to communicate and share resources therebetween.

Operation 402 receives a resource-sharing request from an in-proximity WCD requesting the sharing of resources of a device such as WDRS 100 (FIG. 1). In one embodiment, a resource-sharing request is received from an in-proximity WCD requesting the sharing of resources of another in-proximity WCD. Operation 404 performs an authentication to verify that the in-proximity WCD has authorization to share the requested resource. For example, the authorization may determine whether or not an in-proximity WCD is permitted access to certain data stored on the WDRS or another in-proximity WCD.

Operation 406 proxies incompatible network application layer protocols for the conversion of information between WCDs implementing different network application layer protocols. Operation 406 may employ a proxy sever, such as proxy server 224 (FIG. 2).

Operation 408 performs the requested resource sharing. Operation 408 may include the use of protocol agents 220 (FIG. 2) to interface with different physical interfaces.

In one embodiment of the present invention, resources available on another in-proximity WCD may be invoked. In this embodiment, instead of performing operation 408, operations 410 thorough 414 may be performed. Operation 410 identifies in-proximity WCDs having available resources. Operation 412 checks a resource sharing policy manager on the in-proximity WCD with available resources to determine if the WCD wishes to share its resources. When the policy manager on the other WCD permits or approves the particular resource-sharing request, operation 414 may be performed. Operation 414 may invoke the processing resources of the in-proximity WCD. Operation 414 may include proxying network application layer protocols and converting data between wireless network physical interfaces.

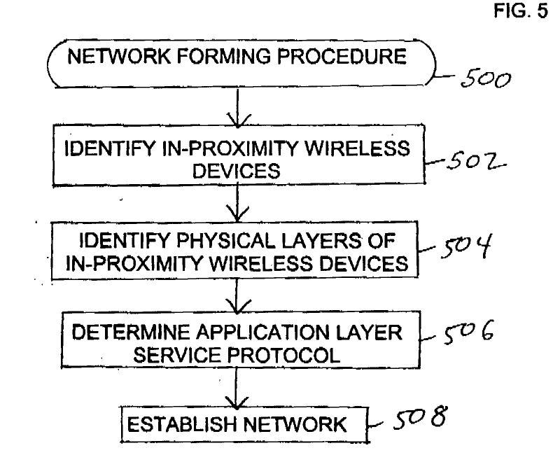

FIG. 5 is a flow chart of a network forming procedure in accordance with an embodiment of the present invention. Wireless devices such as WDRS 100 (FIG. 1), or WDRS 200 (FIG. 2) may perform network forming procedure 500, although other wireless devices are also suitable. In an alternate embodiment, wireless devices, such as WCDs 302 (FIG. 3), may perform all or portions of procedure 500 when, for example, direct resource sharing between devices is implemented. Through the performance of network forming procedure 500, a wireless network may be formed or established allowing both compatible and incompatible wireless devices to communicate therebetween. In one embodiment, through the operation of procedure 500, a WDRS allows incompatible wireless devices to appear as compatible devices. In this way, the WDRS may be “invisible” to such devices allowing the wireless devices to be part of a network of “compatible” devices. In implementing procedure 500, a WDRS may, for example, obtain addresses of wireless devices, and then determine physical layers and/or application layer service protocols of the wireless devices. Although the individual operations of procedure 500 are illustrated and described as separate operations, one or more of the individual operations may be performed concurrently. Further, nothing necessarily requires that the operations be performed in the order illustrated.

Operation 502 identifies in-proximity WCDs. WCDs may be identified in a way similar to the way an ad-hoc network identifies devices. In one embodiment, WCDs are identified through a discovery protocol such as Bluetooth for Bluetooth enabled devices, UPnP for UPnP enabled devices, or JINI for JINI enabled devices. Operation 502 may implement any technique for discovering WCDs.

Operation 504 determines the physical layers of an in-proximity WCD. For example, operation 504 may determine whether an in-proximity WCD communicates using the IEEE 802.11a standard, the IEEE 802.11b standard, the IEEE 802.11g standard, the infrared data association (IRDA) standard, the Bluetooth standard, or a Home-RF standard.

Operation 506 identifies a network application layer protocol of an in-proximity WCD. In one embodiment, the network application layer protocol may correspond with the software discovery protocol, which may be determined in operation 502.

In operation 508, the wireless network is formed. Through the operation of a WDRS, incompatible in-proximity wireless devices may appear as compatible in-proximity wireless devices and may communicate with each other either directly or what appears directly through the WDRS.

The foregoing description of the specific embodiments reveals the general nature of the invention sufficiently that others can, by applying current knowledge, readily modify and/or adapt it for various applications without departing from the generic concept, and therefore such adaptations and modifications are intended to be comprehended within the meaning and range of equivalents of the disclosed embodiments. It is to be understood that the phraseology or terminology employed herein is for the purpose of description and not of limitation. Accordingly, the invention is intended to embrace all such alternatives, modifications, equivalents and variations as fall within the spirit and broad scope of the appended claims.

What is claimed is:

1. A method for sharing resources among wireless communication devices (WCDs) comprising:
identifying in-proximity WCDs;
receiving a resource-sharing request from one of the WCDs; and
performing the resource-sharing request.

2. The method of claim 1 further comprising establishing a communication link with at least one of the WCDs using one of a plurality of wireless network standards.

3. The method of claim 2 wherein the wireless network standards include wireless network physical layers comprising at least one of an IEEE 802.11a standard, an IEEE 802.11b standard, and an IEEE 802.11g standard, and including either an infrared data association (IrDA) standard or a Bluetooth standard.

4. The method of claim 3 further comprising providing substantially a 360-degree coverage area for each included wireless network physical layer standard.

5. The method of claim 3 wherein identifying the in-proximity WCDs includes performing a service discovery protocol (SDP) to identify a network application layer protocol for at least one of the in-proximity WCDs.

6. The method of claim 5 wherein the resource-sharing request is a request to transfer information from a first to a second in-proximity WCD, and wherein performing the resource-sharing request comprises:
receiving information from the first in-proximity WCD, the information comprising data packets configured in accordance with a first network application layer protocol;
converting the ,data packets from the first network application layer protocol to a second network application layer protocol; and
transmitting the converted data packets configured in accordance with the second network application layer protocol to the second of the in-proximity WCDs.

7. The method as claimed in claim 6 wherein the data packets from the first in-proximity WCD are received over a first communication link in accordance with a first of the wireless network physical layers, and wherein the converted data packets are sent to the second in-proximity WCD over a second communication link in accordance with a second of the wireless network physical layers.

8. The method as claimed in claim 7 wherein the first and second network application layer protocols correspond with first and second file transfer protocols implemented respectively by the first and second in-proximity WCDs.

9. The method of claim 3 wherein performing the resource-sharing request comprises storing information from a first in-proximity WCDs for subsequent retrieval by a second in-proximity WCD wireless devices, and wherein the method further comprises:
receiving a request from the second in-proximity WCD to retrieve the information;
authenticating the second in-proximity WCD as having permission to receive the information;
converting the information in accordance with a network application layer protocol identified for the second in-proximity WCD; and
transmitting the information over a communication link in accordance with a wireless network physical layer determined for the second in-proximity WCD.

10. The method of claim 3 wherein the resource-sharing request is a request to process data on behalf of the one in-proximity WCD, and
wherein performing the resource-sharing request comprises:
receiving the data over a wireless communication link implementing one of the wireless network standards; and
processing the data in accordance with the request, and
wherein the method further comprises transmitting processed data to the one wireless device over the wireless communication link.

11. The method of claim 10 wherein the data comprises speech packets and wherein the processing comprising converting the speech packets to text.

12. The method of claim 11 wherein the speech packets are generated substantially in real-time by the one in-proximity WCD from live conversations, and
wherein the transferring comprises sending the converted speech packets to several in-proximity WCDs over wireless links in accordance with wireless network standards identified for each of the several in-proximity WCDs, and
wherein the method further comprises, prior to sending, converting the converted speech packets in accordance with a network application layer protocol identified for each of the several in-proximity WCDs.

13. The method of claim 10 wherein the data comprises hand-writing traces received substantially in real-time by the one in-proximity WCD, and
wherein the processing comprises converting to hand-writing traces to text, and
wherein the transferring comprises sending the text to several in-proximity WCDs over wireless links in accordance with wireless network physical layers identified for each of the several in-proximity WCDs, and
wherein the method further comprises, prior to sending, converting the text in accordance with a network application layer protocol identified for each of the several in-proximity WCDs.

14. The method of claim 3 wherein the resource-sharing request is a request to display data, and
wherein performing the resource-sharing request comprises:
receiving display data from one of the wireless devices over a wireless communication link in accordance with one of the wireless network physical layers;
converting the data for use by a display device; and
routing the data to the display device, the display device being either an overhead projector, a liquid crystal display, or a cathode ray tube display.

15. The method of claim 3 wherein the performing the resource-sharing request invokes resources of a second of the in-proximity WCDs, and wherein the method further comprises:
identifying a second in-proximity WCD having available processing resources;
converting data for processing to a network application layer protocol associated with the second in-proximity WCD;
transmitting the converted data to the second in-proximity WCD over a communication link in accordance with one of the wireless network physical layers identified for the second in-proximity WCD;
receiving processed data from the second in-proximity WCD;
converting the processed data from the network application layer protocol associated with the second in-proximity WCD to a network application layer protocol associated with a first in-proximity WCD; and
transmitting the processed data to the first in-proximity WCD over a communication link in accordance with one of the wireless network physical layers identified for the first in-proximity WCD.

16. A wireless device resource sharer for sharing resources among a plurality of in-proximity wireless communication devices (WCDs) comprising:
plurality of physical interfaces, each to communicate with in-proximity WCDs in accordance with a wireless network physical layer; and
a processor to identify in-proximity WCDs through the physical interfaces and perform resource-sharing requests received by the in-proximity WCDs.

17. The sharer of claim 16 wherein the wireless network physical layers include at least one of an IEEE 802.11a standard, an IEEE 802.11b standard, and an IEEE 802.11g standard, and including either an infrared data association (IrDA) standard or a Bluetooth standard.

18. The sharer of claim 17 wherein the physical interfaces comprise:
a Bluetooth transceiver to provide digital communications in accordance with the Bluetooth standard;
one or more wireless area network (WAN) transceivers to provide digital communications in accordance with at least one of the IEEE 802.11a standard, the IEEE 802.11b standard, or the IEEE 802.11g standard; and
an infrared transceiver to support a infrared serial data link in accordance with the IRDA standard.

19. The sharer of claim 17 wherein the physical interfaces are configured to provide substantially a 360-degree coverage area for each wireless network physical layer supported by the wireless device resource sharer.

20. The sharer of claim 16 wherein the in-proximity WCDs include at least one of a wireless telephone, a personal digital assistant (PDA), a pager, a web-tablet, a portable computer or a wireless headset.

21. The sharer of claim 16 further comprising;
a protocol agent associated with each physical interface to format data packets in accordance with the wireless network physical layer of each physical interface;
a connectivity protocol proxy to route packets among the physical interfaces; and
a proxy server to proxy different network application layer protocols used by the in-proximity WCDs.

22. The sharer of claim 21 further comprising:
a data storage element to perform data storage requests by the in-proximity WCDs; and
a data processing element to perform data processing requests by the in-proximity WCDs.

23. A wireless communication device comprising:
a wireless interface to communicate with an in-proximity wireless communication device (WCD) in accordance with a wireless network physical layer;
a discovery element to identify the in-proximity WCD and to a determine network application layer protocol for communicating with the in-proximity WCD; and
a policy manager to regulate resource sharing with the in-proximity WCD.

24. The device of claim 23 wherein the wireless interface includes at least one transceiver to communicate with in accordance with at least one of an IEEE 802.11a standard, an IEEE 802.11b standard, and an IEEE 802.11g standard, and including either an infrared data association (IrDA) standard or a Bluetooth standard.

25. The device of claim 24 wherein the discovery element includes an agent to proxy incompatible network application layer protocols used for transferring information to the in-proximity WCD.

26. The device of claim 23 wherein further comprising a connectivity decision making element to evaluate connectivity-related inputs for use in making connectivity decisions, the connectivity-related inputs including power consumption of a particular wireless network physical layer when a reduced power consumption is identified as desirable, the connectivity-related inputs including connection speed of the particular wireless network physical layer when a high connection speed is identified as desirable.

27. A computer readable medium having program instructions stored thereon for performing a method for sharing resources among wireless communication devices (WCDs) when executed within a digital processing device, the method comprising:
identifying in-proximity WCDs;
receiving a resource-sharing request from one of the WCDs; and
performing the resource-sharing request,
wherein a communication link is established with at least one of the WCDs using one of a plurality of wireless network physical layers.

28. The computer readable medium of claim 27 wherein the wireless network physical layers comprising at least one of an IEEE 802.11a standard, an IEEE 802.11b standard, and an IEEE 802.11g standard, and including either an infrared data association (IrDA) standard or a Bluetooth standard.

29. The computer readable medium of claim 28 wherein the method further comprises:
using a protocol agent associated with each physical interface to format data packets in accordance with the wireless network physical layer of the physical interface;
using a connectivity protocol proxy to route packets among the physical interfaces; and
using a proxy server to proxy different network application layer protocols between the in-proximity wireless communication devices.

30. A method of selecting network connectivity comprising:
discovering available wireless network physical layers;
evaluating policies that relate to the available network physical layers; and
automatically selecting one of the available network physical layers based at least on the policies.

31. The method of claim 30 wherein discovering, evaluating and automatically selecting is performed by a wireless communication device (WCD), and
wherein evaluating comprises evaluating a battery level of the WCD, and
wherein the automatically selecting includes selecting one of the available network physical layers based on the battery level.

32. The method of claim 31 wherein the WCD includes a database to store prior connectivity information for the available network physical layers, and
wherein evaluating includes evaluating the prior connectivity information, and
wherein the automatically selecting includes selecting one of the available network physical layers based on the prior connectivity information.

33. A resource sharing system comprising:
a physical interface to communicate with wireless communication devices (WCDs) in accordance with a network physical layer that includes an IEEE 802.11 standard, the physical interface including a WLAN transceiver to provide digital communications in accordance with at one of the IEEE 802.11 standard; and
a processor to identify in-proximity WCDs through the physical interface and to perform resource-sharing requests received by the in-proximity WCDs.

34. The system of claim 33 further comprising a protocol agent associated with the physical interface to format data packets in accordance with the wireless network physical layer associated with the physical interface.

35. The system of claim 34 further comprising:
a connectivity protocol proxy to route packets among the different physical interfaces; and
a proxy serving element to proxy different network application layer protocols used by the in-proximity WCDs.

36. A method of communicating between incompatible wireless devices comprising:
receiving communications from a first wireless device;
transforming the communications to a format compatible for receipt by a second wireless device; and
relaying the communications from the first wireless to the second wireless device.

37. The method of claim 36 wherein the first and second wireless devices have substantially incompatible network physical layers, and wherein transforming comprises using protocol agents to re-format data packets between the incompatible network physical layers allowing the data packets to be utilized by a first network physical layer utilized by the first wireless device to a second network physical layer utilized by the second wireless device.

38. The method of claim 36 wherein the first and second wireless devices have substantially incompatible application layer service protocols, and wherein transforming comprises using a proxy server to proxy the incompatible application layer protocols allowing data to be converted from a first application layer protocol utilized by the first wireless device to a second application layer protocol utilized by the second wireless device.
